(19) United States
(12) Patent Application Publication
(10) Pub. No.: US 2023/0019175 A1
(43) Pub. Date: Jan. 19, 2023

(54) POWER STORAGE DEVICE AND POWER STORAGE MODULE

(71) Applicant: Panasonic Holdings Corporation, Osaka (JP)

(72) Inventor: TETSUJI OMURA, Hyogo (JP)

(21) Appl. No.: 17/757,770

(22) PCT Filed: Dec. 22, 2020
(86) PCT No.: PCT/JP2020/047897

§ 371 Date: Jun. 20, 2022

(30) Foreign Application Priority Data
Dec. 27, 2019 (JP) 2019-238131

(51) Int. Cl. H01M 10/0585; H01M 50/147; H01M 50/204; H01M 50/183; H01M 10/056

(52) U.S. Cl. CPC H01M 10/0585; H01M 50/147; H01M 50/204; H01M 50/183; H01M 10/056

(57) ABSTRACT

A power storage device includes an electrode assembly including a positive-electrode plate and a negative-electrode plate stacked with a separator interposed between the positive-electrode plate and the negative-electrode plate, an exterior can accommodating the electrode assembly and an electrolyte solution, and including a side wall portion having a tubular shape and an opening provided at least at one end of the side wall portion, and a sealing plate that closes the opening of the exterior can. The sealing plate is joined to the opening at a joint. Each of a pair of long walls of the side wall portion facing each other in a depth direction includes a thin part extending in a width direction.

### TECHNICAL FIELD

The present disclosure relates to a power storage device and a power storage module.

### BACKGROUND ART

A conventional power storage device in which a sealing plate is welded to an opening of an exterior can is disclosed as in PTL 1.

### CITATION LIST

### Patent Literature

PTL 1: Japanese Patent Laid-Open Publication No. 2018-190510

### SUMMARY OF THE INVENTION

### Technical Problem

A power storage device may expand due to various factors such as aging degradation of an electrode assembly and expansion or contraction of the electrode assembly. An expansion of a power storage device in which a sealing plate is joined to an opening of an exterior can is likely to generate mechanical stress in a peripheral edge of a side surface of the exterior can. An end of a side wall constitutes the opening. Thus, mechanical stress may be allied to a joint where the opening is joined to the sealing plate. An excessive stress generated in the joint may cause the joint to break.

An object of the present disclosure is to provide a power storage device and a power storage module that are highly reliable.

### Solution to Problem

A power storage device according to an aspect of the present disclosure includes an electrode assembly including a positive-electrode plate and a negative-electrode plate stacked with a separator interposed between the positive-electrode plate and the negative-electrode plate, an exterior can accommodating the electrode assembly and an electrolyte solution, and including a side wall portion having a tubular shape and an opening provided at least at one end of the side wall portion, and a sealing plate closing the opening of the exterior can. A peripheral end of the sealing plate is joined to the opening at a joint. The side wall portion includes a pair of side walls facing each other in a first direction. Each of the pair of side walls includes a thin part extending in a second direction perpendicular to the first direction.

### Advantageous Effect of Invention

According to one aspect of the present disclosure, when the power storage device expands, the thin part formed in the exterior can deforms prior to other parts. This configuration reduces mechanical stress generated in a joint between the exterior can and a sealing plate, thus enhancing reliability of the power storage device.

### BRIEF DESCRIPTION OF THE DRAWINGS

FIG. 1 is a cross-sectional view of a power storage device according to an exemplary embodiment perpendicular to a first direction (depth direction).

FIG. 2 is a front view of the power storage device according to the embodiment.

FIG. 3 is a cross-sectional view of the power storage device taken along line AA shown in FIG. 2.

FIG. 4 illustrates an effect of the power storage device according to the embodiment.

FIG. 5 is a cross-sectional view of another power storage device according to the exemplary embodiment corresponding to the AA cross section shown in FIG. 2.

FIG. 6 is a front view of an exterior can of another device according to the embodiment.

FIG. 7 is a cross-sectional view of an exterior can of another device according to the embodiment corresponding to the AA cross-section shown in in FIG. 2.

FIG. 8 is a cross-sectional view of a power storage module according to the embodiment perpendicular to the first direction (depth direction).

FIG. 9 illustrates an effect of the power storage module according to the embodiment.

### DESCRIPTION OF EMBODIMENT

Hereinafter, an exemplary embodiment of the present disclosure will be described with reference to the drawings. Shapes, materials, and numbers described below are examples for description, and can be appropriately changed according to a specification of a power storage device or a power storage module. In the following description, the same elements are denoted by the same reference mark in all the drawings.

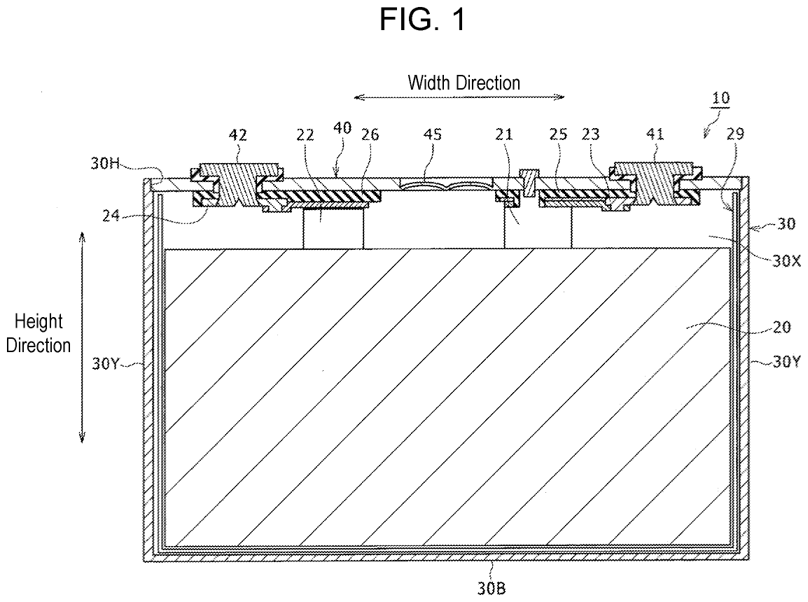

Power storage device 10 which is an example of an exemplary embodiment will be described with reference to FIG. 1. FIG. 1 is a cross-sectional view of power storage device 10.

Power storage device 10 which is an example of the exemplary embodiment is a non-aqueous electrolyte secondary battery, typically a lithium ion battery. Power storage device 10 may be a nickel metal hydride battery or an electric double layer capacitor. Power storage device 10 is used for, for example, a drive power source for an electric vehicle or a hybrid vehicle, or a stationary power storage system for peak shifting of system power. Power storage device 10 includes electrode assembly 20 in which a positive-electrode plate and a negative-electrode plate are stacked with a separator interposed therebetween, exterior can 30 accommodating electrode assembly 20 and an electrolyte solution, and sealing plate 40 closing opening 30H of exterior can 30.

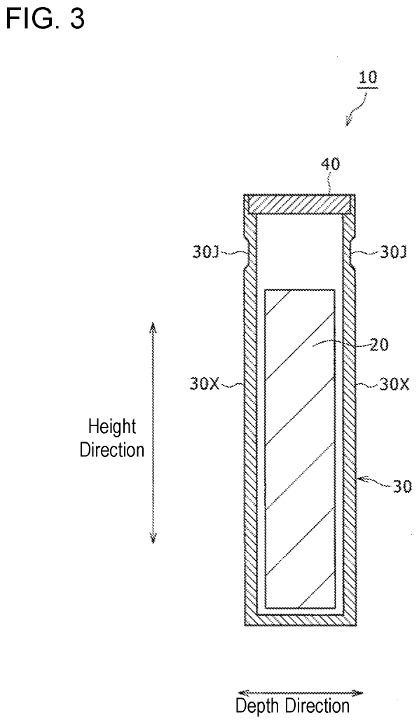

Hereinafter, for convenience of description, a height direction is defined such that sealing plate 40 of exterior can 30 is in an upper side and the opposite side of sealing plate 40 is the lower side. A width direction is defined as a second direction in which positive-electrode terminal 41 and negative-electrode terminal 42 are arranged. A depth direction (see FIG. 3) is defined as a first direction perpendicular to the height direction and the width direction.

Electrode assembly 20 is formed by stacking a positive-electrode plate, a negative-electrode plate, and a separator, all of which have substantially rectangular sheet shapes. The stacked positive-electrode plate, negative-electrode plate, and separator may be bound with a fastening tape, or the separator may be fixed to the positive-electrode plate or the negative-electrode plate by adhesion by applying an adhesive to a surface of the separator facing the positive-electrode plate or the negative-electrode plate. Electrode assembly 20 is accommodated in substantially rectangular-parallelepiped insulating holder 29 having a bottom and an upper end which opens. Electrode assembly 20 is disposed in exterior can 30 such that a stacking direction in which the positive-electrode plate and the negative-electrode plate are stacked is parallel to the depth direction of exterior can 30. Electrode assembly 20 may be formed by winding a strip-shaped positive-electrode plate and a strip-shaped negative-electrode plate with a strip-shaped separator interposed therebetween to form a wound body, and then flattening the wound body to form a flat wound body. In this case, the stacking direction of electrode assembly 20 may be a thickness direction of the flat wound body.

The positive-electrode plate includes, for example, a core made of an aluminum foil having a thickness of 15 μm, electrode layers formed on front and back surfaces of the core, a core exposed part of the core where no electrode layer is formed on the core, and positive-electrode lead 21 extending from an upper end of the core exposed part.

The electrode layer of the positive electrode contains, for example, an active material, a conductive agent, and a binder. For the positive electrode, lithium-nickel-cobalt-manganese composite oxide may be employed as the active material, polyvinylidene fluoride (PVdF) may be employed as the binder, a carbon material may be employed as the conductive agent, and N-methylpyrrolidone (NMP) can be employed as a dispersion medium. When forming the electrode layer, a slurry containing the active material, the conductive agent, the binder, and the dispersant is prepared. The slurry is applied on both surfaces of the core of the positive electrode. Then, upon being dried, the dispersion medium in the slurry is removed, thereby forming an electrode layer on the core. After that, the electrode layer is compressed to have a predetermined thickness. The positive-electrode plate thus obtained is cut into a predetermined shape.

The negative-electrode plate includes, for example, a core made of a copper foil having a thickness of 8 μm, electrode layers formed on front and back surfaces of the core, a core exposed part of the core where no electrode layer is formed on the core, and negative-electrode lead 22 extending from an upper end of the core exposed part.

The electrode layer of the negative electrode contains, for example, an active material, a conductive agent, a binder, and a thickener. For the negative electrode, graphite may be employed as the active material, styrene butadiene rubber (SBR) may be employed as the binder, carboxymethyl cellulose (CMC) may be employed as the thickener, and water may be employed as a dispersion medium. When forming the electrode layer, a slurry containing the active material, the conductive agent, the binder, and the thickener is prepared. The slurry is applied on both surface of the core of the negative electrode. Then, upon being dried, the dispersion medium in the slurry is removed, thereby forming an electrode layer on the core. After that, the electrode layer is compressed to have a predetermined thickness. The negative-electrode plate thus obtained is cut into a predetermined shape.

For example, a resin separator may be employed as the separator. Polyolefin, polyethylene, or polypropylene may be employed as the resin.

Positive-electrode lead 21 is electrically connected via collector 23 to positive-electrode terminal 41 provided on sealing plate 40. The number of positive-electrode leads 21 provided is the number of positive-electrode plates constituting electrode assembly 20. A plurality of positive-electrode leads 21 are bundled at their distal sides in the extending direction, and joined to collector 23. Joining of positive-electrode leads 21 to collector 23 can be made by ultrasonic welding, resistance welding, laser welding, cold welding, or the like.

Negative-electrode lead 22 is electrically connected via collector 24 to negative-electrode terminal 42 provided on sealing plate 40. The number of negative-electrode leads 22 provided is the number of negative-electrode plates constituting electrode assembly 20. A plurality of negative-electrode leads 22 are bundled at their distal sides in the extending direction, and joined to collector 24. Joining of negative-electrode leads 22 to collector 24 can be made by ultrasonic welding, resistance welding, laser welding, cold welding, or the like.

Collector 23 of the positive electrode is made of, for example, an aluminum plate. Collector 23 is connected to positive-electrode lead 21 at one end and to positive-electrode terminal 41 at the other end. Insulator 25 is interposed between collector 23 and sealing plate 40.

Positive-electrode terminal 41 may be electrically connected to collector 23 via a current interrupt device (CID). The CID is a safety device configured to cut off electrical connection between collector 23 and positive-electrode terminal 41 when an abnormality occurs in power storage device 10 and gas is generated inside exterior can 30 to raise the pressure in exterior can 30 to exceed a predetermined pressure. The CID includes, for example, an invertible plate connected to the other end of collector 23 and configured to deform in a direction away from collector 23 upon receiving pressure in exterior can 30, and a conductive cap electrically connects the invertible plate to positive-electrode terminal 41. The conductive cap is a dish-shaped conductor having an opening to the lower side (toward electrode assembly 20) and an upper surface on the upper side (toward sealing plate 40). The upper surface has a connection hole therein in which positive-electrode terminal 41 is inserted.

Collector 24 of the negative electrode is made of, for example, a copper plate. One end of collector 24 is connected to negative-electrode lead 22 and another end of collector 24 is connected to negative-electrode terminal 42. Insulator 26 is disposed between collector 24 and sealing plate 40.

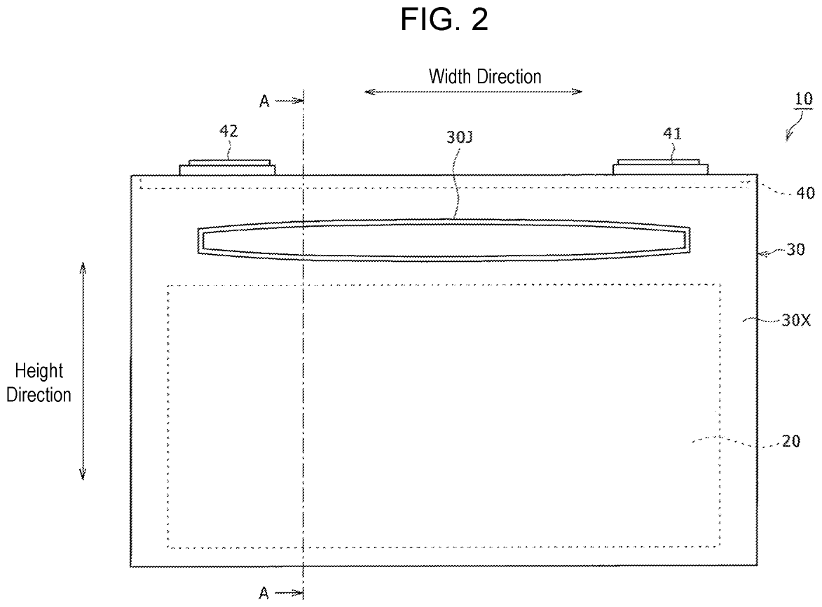

Exterior can 30 is, for example, a rectangular case including bottom 30B, a side wall portion having a rectangular tubular shape extending up from a peripheral edge of bottom 30B, and opening 30H at an end portion opposite to bottom 30B. Exterior can 30 is made of, for example, metal such as aluminum. Exterior can 30 may be formed by, for example, drawing an aluminum material. The side wall portion with each tubular shape includes two long walls 30X facing each other in the depth direction, and two short walls 30Y facing each other in the width direction. Each of long walls 30X includes thin part 30J, which will be detailed later (see FIG. 2 and FIG. 3).

Positive-electrode terminal 41 and negative-electrode terminal 42 are disposed on sealing plate 40 and apart from each other in a longitudinal direction (the width direction in FIG. 1) of sealing plate 40. Positive-electrode terminal 41 and negative-electrode terminal 42 protrude from the upper surface of sealing plate 40. Sealing plate 40 is formed by, for example, processing an aluminum plate. Sealing plate 40 is located at opening 30H of exterior can 30. The inside of exterior can 30 may be sealed by welding sealing plate 40 to the opening end of exterior can 30 with, for example, a laser or the like.

Sealing plate 40 may have a liquid supply hole therein through which an electrolyte solution is supplied into exterior can 30. Sealing plate 40 may include a liquid supply plug to close the liquid supply hole. Sealing plate 40 may include pressure regulating valve 45 including plural grooves along an outer periphery of the valve so that when the pressure in exterior can 30 exceeds a predetermined pressure, the grooves tear to discharge the gas in exterior can 30 to the outside. The groove may preferably have an annular shape extending along the peripheral edge of the upper surface of sealing plate 40. With this configuration, when sealing plate 40 is joined to opening 30H of exterior can 30 by welding, the peripheral edge of sealing plate 40 may be melted efficiently.

Positive-electrode terminal 41 passes through a terminal hole provided in sealing plate 40. One end of positive-electrode terminal 41 is exposed to the outside of exterior can 30 and the other end of positive-electrode terminal 41 is accommodated in exterior can 30. The other end of positive-electrode terminal 41 is inserted in the connection hole provided in the upper surface of the conductive cap. The other end of positive-electrode terminal 41 is crimped to expand radially outward, thereby fixing positive-electrode terminal 41 to the conductive cap. Positive-electrode terminal 41 has, for example, a columnar body or tubular body made of aluminum.

Negative-electrode terminal 42 passes through a terminal hole in sealing plate 40. One end of negative-electrode terminal 42 is exposed to the outside of exterior can 30 and the other end of negative-electrode terminal 42 is accommodated in exterior can 30. Negative-electrode terminal 42 is made of, for example, a clad material in which the other end of the clad material connected to collector 24 in exterior can 30 is made of a copper material and one end of the clad material exposed to the outside of exterior can 30 is made of aluminum. The other end of negative-electrode terminal 42 is crimped to expand radially outward, thereby fixing negative-electrode terminal 42 to sealing plate 40 together with collector 24.

Exterior can 30 will be detailed with reference to FIG. 2 and FIG. 3. FIG. 2 is a front view of power storage device 10. FIG. 3 is a cross-sectional view of the device taken along line AA shown in FIG. 2.

As illustrated in FIG. 2 and -FIG. 3, thin part 30J extends along the width direction in each long wall 30X of exterior can 30 according to the embodiment. As detailed later, thin part 30J reduces mechanical stress generated in the joint between exterior can 30 and sealing plate 40 when power storage device 10 expands, thus enhancing reliability of power storage device 10.

Thin part 30J is formed below the joint where exterior can 30 is joined to sealing plate 40. In other words, thin part 30J is formed below sealing plate 40 in long wall 30X of exterior can 30 along the height direction of long wall 30X of exterior can 30. Thin part 30J is formed above accommodated electrode assembly 20 along the height direction of long wall 30X of exterior can 30. In other words, thin part 30J is not formed at the same location as accommodated electrode assembly 20 along the height direction of long wall 30X of exterior can 30.

Thin part 30J is formed below sealing plate 40 and above electrode assembly 20. This configuration allows a region of long wall 30X not including a portion of long wall 30X on the upper side of the thin part 30J and includes the joint with sealing plate 40 to be bent (deform) prior to other regions of long wall 30X when power storage device 10 expands and long wall 30X deforms to have arc shape convex to outward.

Thin part 30J is not formed at the same location as accommodated electrode assembly 20 along the height direction. When long wall 30X of exterior can 30 is pressed from the outside by a holding member or the like in power storage device 10, for example, the pressing force may be uniformly applied to the electrode assembly 20. This is because when a pressed region includes a thin part region and a region with no thin part, the regions are different from each other in deformability, the magnitude of stress transmitted to the electrode assembly via the region depends on the position of the region.

Thin part 30J is provided in each long wall 30X of exterior can 30 to cause the outer surface of long wall 30X to have a recess therein. The rise of a step of the recess of thin part 30J has a gentle slope with respect to the surface of long wall 30X. The gentle slope means that thin part 30J has an inner bottom surface and an inner side surface rising from the inner bottom surface, the inner side surface constitutes the slope, and the angle of the slope with respect to the inner bottom surface is equal to or more than 90°. The angle may be equal to or more than 135°. This slope suppresses stress concentrating to a portion where the bottom surface of thin part 30J us joined to the slope caused by deformation of long wall 30X. This configuration allows thin part 30J to hardly break sue to expansion of exterior can 30. As will be detailed later with reference to another example of the exemplary embodiment, thin part 30J may be provided in each long wall 30X of exterior can 30 to have a recess in an inner surface of each long wall 30X. Thin part 30J may be provided in each long wall 30X of exterior can 30 to have recesses in both the outer and inner surfaces of each long wall 30X. The rise at the step of the recess constituting thin part 30J may be perpendicular to the surface of long wall 30X.

A dimension of thin part 30J in the width direction is smaller than a dimension of long wall 30X in the width direction. In more detail, thin part 30J does not reach a ridge of long wall 30X connected to short wall 30Y in the width direction. The center of thin part 30J along the width direction substantially coincides with the center of long wall 30X along the width direction.

Thin part 30J includes a center portion and end portions along the width direction. The dimension of the center portion 30J in the height direction is larger than the dimension of the end portions in the height direction. In more detail, regarding the shape of a border of the opening recess of thin part 30J have an upper step (in more detail, the start position and the end position of the step) having an arc shape convex upward when viewed in the depth direction and a lower step (in more detail, the start position and the end position of the step) having an arc shape convex downward when viewed in the depth direction.

Both the end portions of long wall 30X of exterior can 30 along the width direction are close to corners of exterior can 30, hence being rigid. Accordingly, when power storage device 10 expands, for example, a center portion of long wall 30X along the width direction deforms more largely than both end portions of long wall 30X along the width direction. The center portion of thin part 30J along the width direction has the dimension in the height direction larger than the dimension in the height direction of both the end portions of thin part 30J along the width direction. This configuration suppresses a load applied to a center portion of the joint along the width direction which largely deforms due to expansion of power storage device 10. Besides the dimensions in the height direction, a depth of the recess at the center portion of the thin part in the width direction of the thin part may be larger than a depth of the recess at the end portions of the thin part in the width direction, thereby providing the same effect.

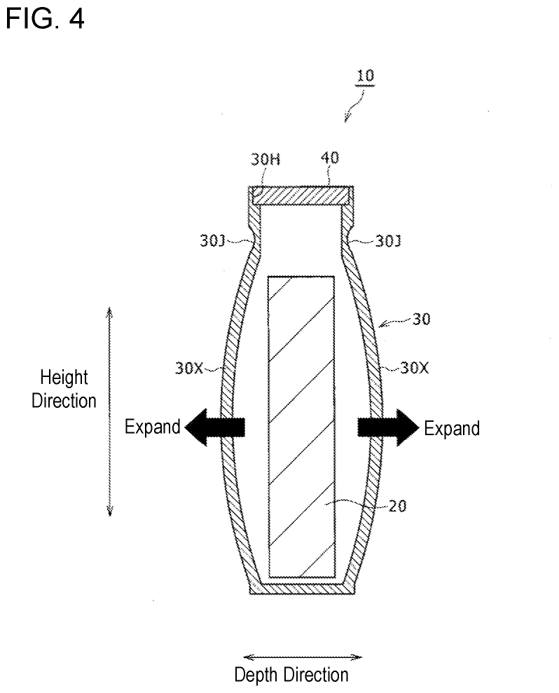

An effect of power storage device 10 including thin part 30J will be described below with reference to FIG. 4.

Power storage device 10 may expand due to various factors such as aging degradation of power storage device 10 and expansion or contraction of electrode assembly 20. Expansion of power storage device 10 in which sealing plate 40 is joined to opening 30H of exterior can 30 by welding may generate mechanical stress in the joint. An excessive stress generated in the joint may break the joint.

As illustrated in FIG. 4, in power storage device 10 according to the embodiment, when power storage device 10 expands, long wall 30X deforms to have an arc shape convex outward, thereby causing thin part 30J of long wall 30X to be largely bent. Meanwhile, the deformation of a portion of long wall 30X above thin part 30J of exterior can 30 is reduced, and thus the mechanical stress generated in the joint can be reduced. This configuration suppresses breakage of the joint, and enhances the reliability of power storage device 10 accordingly.

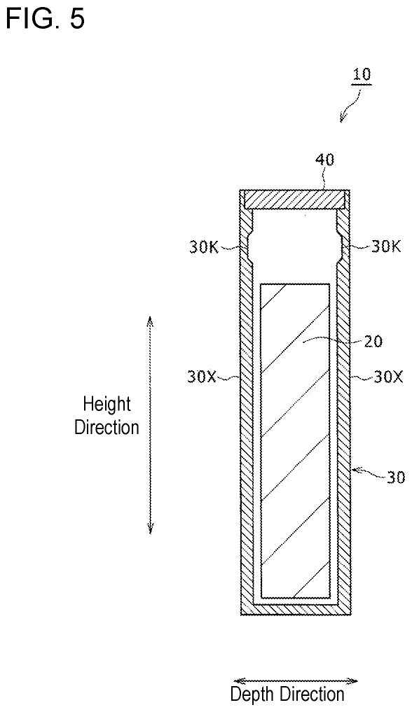

Exterior can 30 which is another example of the present exemplary embodiment will be described with reference to FIG. 5. FIG. 5 is a cross-sectional view corresponding to the AA cross section in FIG. 2.

As illustrated in FIG. 5, long wall 30X of exterior can 30 as another example of the embodiment includes thin part 30K extended in the width direction. Thin part 30K is provided in each long wall 30X of exterior can 30 to have a recess in the inner surface of long wall 30X. Thin part 30K is similar to thin part 30J described above except that thin part 30K is formed in the inner side of each long wall 30X of exterior can 30. Thin part 30K has substantially the same effect as thin part 30J described above.

Thin part 30K is provided in each of long wall 30X of exterior can 30 to have a recess in the inner surface of long wall 30X with a step of the recess having a gentle slope. This configuration prevents electrode assembly 20 from being damaged by the step of the recess when electrode assembly 20 is inserted into exterior can 30 in a manufacturing process of power storage device 10 as compared with an exterior can having a recess therein with a step having an angle of 90°.

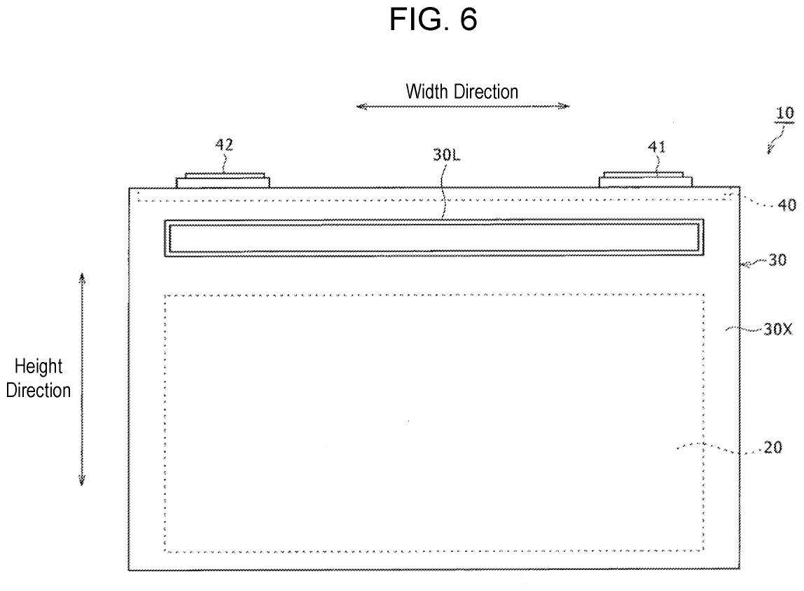

Exterior can 30 which is another example of the present exemplary embodiment will be described with reference to FIG. 6. FIG. 6 is a front view of power storage device 10.

As illustrated in FIG. 6, long wall 30X of exterior can 30 as another example of the embodiment includes thin part 30L extended in the width direction. Thin part 30L has a step (in more detail, the start position and the end position of the step) having substantially a rectangular shape when viewed in the depth direction. In other words, a border of the recess of thin part L has substantially a rectangular shape. Thin part 30L is similar to thin part 30J described above except that thin part 30L has a step with a rectangular shape. This configuration provides an effect substantially similar to the effect of power storage device 10 including thin part 30J.

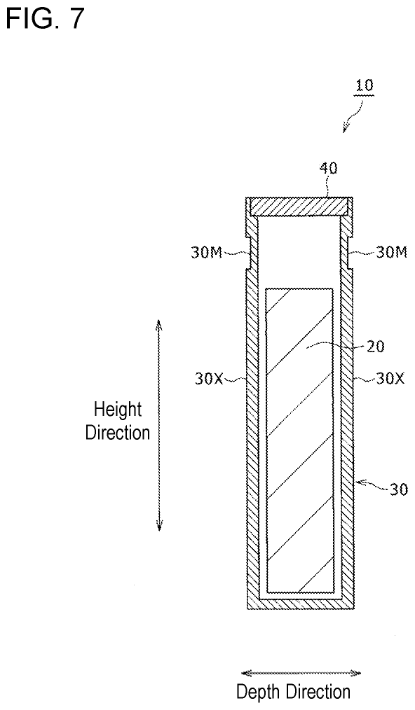

Exterior can 30 which is another example of the embodiment will be described with reference to FIG. 7. FIG. 7 is a cross-sectional view of power storage device 10 corresponding to the AA cross section in FIG. 2.

As illustrated in FIG. 7, long wall 30X of exterior can 30 as another example of the embodiment includes thin part 30M extended in the width direction. A step of a recess at thin part 30M is formed perpendicularly. Thin part 30M is similar to thin part 30J described above except that thin part 30M has a perpendicular step. This configuration provides an effect substantially similar to the effect of power storage device 10 including thin part 30J.

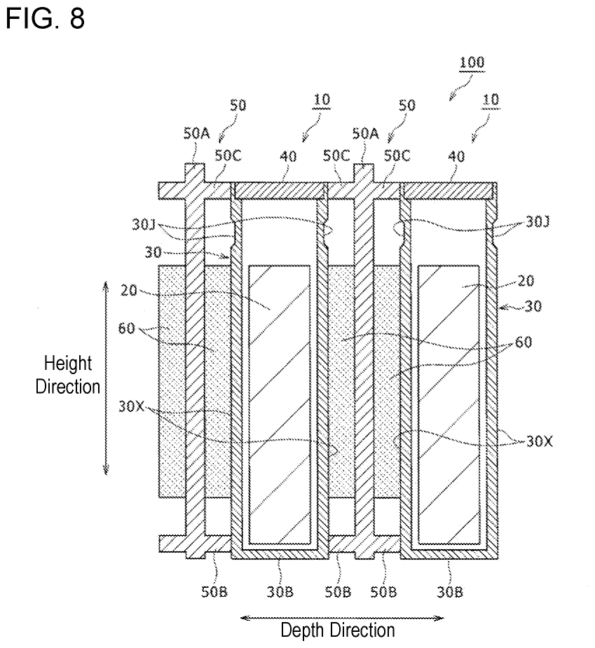

Power storage module 100 including power storage devices 10 will be described with reference to FIG. 8. FIG. 8 is a cross-sectional view of the module corresponding to the AA cross section in FIG. 2.

Power storage module 100 which is an example of the exemplary embodiment may be mainly used as a power source for powering. Power storage module 100 is used as a power source for a motor-driven electrically powered device such as an electrically powered tool, an electrically powered assisted bicycle, an electrically powered motorcycle, an electrically powered wheelchair, an electrically powered tricycle, and an electrically powered cart. However, the application of power storage module 100 is not specified. Power storage module 100 may be used as a power source for electric devices other than electrically powered devices. The electric devices may be of various kinds used indoors and outdoors, such as cleaners, wireless devices, lighting devices, digital cameras, and video cameras.

For convenience of description, like power storage device 10, the following description is made based on the depth direction as a first direction, the width direction as a second direction, and the height direction.

As shown in FIG. 8, power storage module 100 includes power storage devices 10 arranged in the depth direction, and spacers 50 as holding members each provided between respective adjacent power storage devices 10. Buffers 60 are each provided between power storage device 10 and spacer 50. In power storage module 100 according to the embodiment, power storage device 10 includes, e.g., thin part 30J formed in long wall 30X of exterior can 30 described above, but the present invention is not limited to this configuration. Power storage device 10 may include, for example, thin part 30K formed in long wall 30X of exterior can 30 described above.

Spacer 50 insulates adjacent power storage devices 10 from each other and adjusts the dimension of power storage module 100 in the depth direction. Spacer 50 is made of, for example, a thermoplastic resin such as polypropylene, polystyrene, polycarbonate, polybutylene terephthalate, and Noryl (registered trademark) resin (denatured PPE). However, the material of the spacer 50 is not particularly limited.

Spacer 50 includes a main body 50A having a plate shape, a lower-end holding part 50B holding a lower end portion of power storage device 10, and an upper-end holding part 50C holding an upper end portion of power storage device 10. Main body 50A has substantially the same shape as long wall 30X of exterior can 30 when viewed in the depth direction. More specifically, lower-end holding part 50B holds a lower end portion of long wall 30X of exterior can 30, the lower end portion being a vicinity of bottom 30B of exterior can 30. Upper-end holding part 50C holds an upper end portion of long wall 30X of exterior can 30, the upper end portion being a vicinity of the joint between exterior can 30 and sealing plate 40.

Lower-end holding part 50B of spacer 50 holds the lower end portion of long wall 30X while the upper-end holding part 50C holds the upper end portion of long wall 30X, thereby suppressing deformation of the upper end portion and the lower end portion of long wall 30X produced when power storage device 10 expands. This configuration reduces a mechanical stress generated in the joint between exterior can 30 and sealing plate 40 at the upper end portion, and thereby, prevents the joint from breaking, thus enhancing the reliability of power storage device 10.

Buffer 60 is made of a material softer than spacer 50, for example, thermosetting elastomers such as natural rubber, synthetic rubber, urethane rubber, silicone rubber, and fluororubber, or thermoplastic elastomers such as polystyrene, olefin, polyurethane, polyester, and polyamide. These materials may be foamed, but are not particularly limited.

Buffer 60 is disposed between long wall 30X of exterior can 30 and main body 50A of spacer 50, and holds a substantially center portion of long wall 30X of exterior can 30 along the height direction. The dimension of buffer 60 in the width direction is, for example, equal to or more than the dimension of electrode assembly 20 in the width direction, and is preferably substantially equal to the dimension of long wall 30X of exterior can 30. The dimension of buffer 60 in the height direction is, for example, equal to or more than the dimension of electrode assembly 20 in the height direction, and is preferably smaller than the distance between lower-end holding part 50B and upper-end holding part 50C of spacer 50. The buffer with the above dimensions further uniformly presses the surfaces of the positive-electrode plate and the negative-electrode plate of electrode assembly 20.

Buffer 60 holds the substantially center portion in the height direction of long wall 30X, so that when power storage device 10 expands, the expansion of the center portion of long wall 30X can be absorbed. Accordingly, as compared with a case where the center portion of long wall 30X is held by a rigid body, for example, the reaction force against a holding member can be reduced and the power storage module can be downsized.

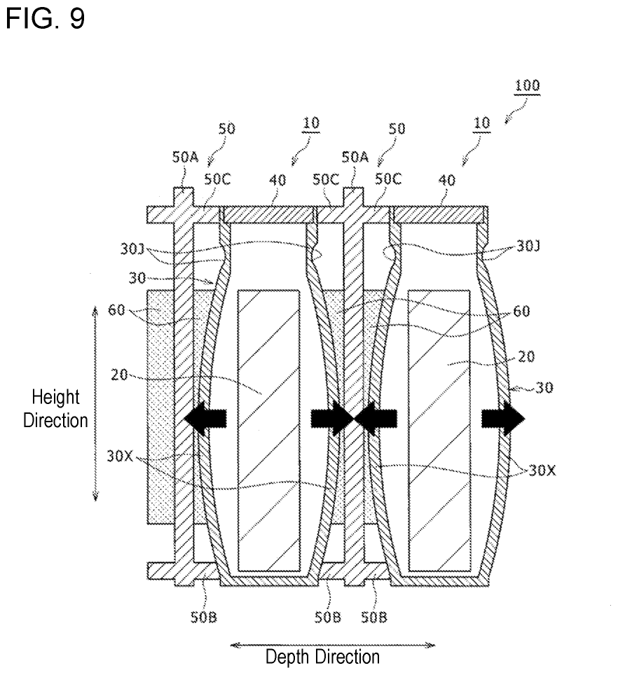

An effect of power storage module 100 including power storage devices 10 will be described with reference to FIG. 9.

As illustrated in FIG. 9, when power storage device 10 expands, the center portion of long wall 30X deforms so as to bulge outward but upper-end holding part 50C of spacer 50 holds the joint between exterior can 30 and sealing plate 40, so that the mechanical stress generated in the joint can be reduced. This configuration prevents the joint from breaking, and enhances the reliability of power storage device 10. In addition, buffer 60 absorbs the bulging of the center portion of long wall 30X, so that the reaction force against the holding member may be reduced more and the power storage module may have a smaller size than a device including the center portion long wall 30X held with a rigid body

The present disclosure is not limited to the above-described exemplary embodiment and modified examples thereof, and it is a matter of course that various changes and improvements can be made within the scope of the content described in the claims of the present application. For example, in the exemplary embodiment described above, description has been made for the power storage device using a single sealing plate for an exterior can. However, the present invention is not limited to this configuration. For example, the sealing plate may be joined to an opening at each of both ends of the side wall portion with a tubular shape to provide sealing. In this case, a thin part may be provided in a vicinity of each of both the sealing plates. In this case, a spacer may be provided between the sealing plate and the electrode assembly so as to locate the electrode assembly away from both sealing plates by a predetermined distance. This configuration allows only electrode assembly 20 to be pressed while preventing the thin part from being pressed.

### REFERENCE MARKS IN THE DRAWINGS

10 power storage device
20 electrode assembly
21 positive-electrode lead
22 negative-electrode lead
23 collector
24 collector
25 insulator
26 insulator
29 insulating holder
30 exterior can
30B bottom
30H opening
30J thin part
30K thin part
30L thin part
30M thin part
30X long wall
30Y short wall
40 sealing plate
41 positive-electrode terminal
42 negative-electrode terminal
45 pressure regulating valve
50 spacer
50A main body
50B lower-end holding part
50C upper-end holding part
60 buffer
100 power storage module

1. A power storage device comprising:
an electrode assembly including a positive-electrode plate, a negative-electrode plate, and a separator such that the positive-electrode plate and a negative-electrode plate are stacked with a separator interposed between the positive-electrode plate and the negative-electrode plate;
an exterior can accommodating the electrode assembly and an electrolyte solution therein, the exterior can including a side wall portion having a tubular shape and an opening provided at least at one end of the side wall portion; and
a sealing plate closing the opening of the exterior can, wherein
a peripheral edge of the sealing plate is joined to the opening at a joint, and
the side wall portion includes a pair of side walls facing each other in a first direction, each of the pair of side walls including a thin part extending in a second direction perpendicular to the first direction.

2. The power storage device according to claim 1, wherein the thin part is provided between the electrode assembly and the joint.

3. The power storage device according to claim 1, wherein the thin part includes a center portion and an end portion along the second direction, a dimension of the center portion of the thin part in a third direction perpendicular to in a direction perpendicular to the second direction being larger than a dimension of the end portion of the thin part in the direction perpendicular to the second direction.

4. The power storage device according to claim 1, wherein the thin part is provided in the each of the pair of side walls of the exterior such that an outer surface of the each of the pair of side walls of the exterior can has a recess therein at the thin part.

5. The power storage device according to claim 4, wherein the recess has an inclining step.

6. The power storage device according to claim 1, wherein the first direction is parallel to a direction in which the positive-electrode plate and the negative-electrode plate are stacked.

7. A power storage module comprising
a plurality of power storage devices arranged along the first direction, each of the plurality of power storage devices being a power storage device according to claim 1; and
a holding member provided between adjacent power storage devices out of the plurality of the power storage devices.

8. The power storage module according to claim 7, wherein the holding member holds at least a vicinity of the joint in a third direction perpendicular to the sealing plate.

9. The power storage module according to claim 7, further comprising
a buffer disposed between the power storage device and the holding member, wherein
the buffer holds a center portion of the exterior can along a third direction perpendicular to the sealing plate, and is made of a material softer than the holding member.
